(19) United States
(12) Patent Application Publication
(10) Pub. No.: US 2016/0144762 A1
(43) Pub. Date: May 26, 2016

(54) Vehicle Caddy

(71) Applicant: Ricardo Bovero, Tampa, FL (US)

(72) Inventor: Ricardo Bovero, Tampa, FL (US)

(21) Appl. No.: 14/551,691

(22) Filed: Nov. 24, 2014

(51) Int. Cl. B60P 3/07

(52) U.S. Cl. CPC B60P 3/07

(57) ABSTRACT

Disclosed is a caddy system for personal vehicle. As a two or three-wheeled vehicle. The term “personal vehicle” as used herein is intended as a broad classification for two and three wheeled motorcycles. It further includes three and four wheeled all-terrain (ATV) vehicles. In broad terms, the caddy includes a platform that is supported by a series of wheels. The caddy is designed to be tipped forwardly or rearwardly as needed to allow the vehicle to enter onto and exit off the platform. Once upon the caddy, a single user can easily move, maneuver, or manipulate the vehicle. This is ideal for storing and/or maintaining the vehicle.

### TECHNICAL FIELD

This disclosure relates to a vehicle caddy. More particularly, the present disclosure relates to a movable platform for storing and transporting vehicles.

### BACKGROUND OF THE INVENTION

The popularity of personal vehicles has dramatically increased in recent years. The term “personal vehicle” as used herein is intended as a broad classification for two and three wheeled motorcycles. It further includes three and four wheeled all-terrain (ATV) vehicles. Personal vehicles are generally much smaller than automobiles and are intended to be ridden by one or two people.

Personal vehicles often must be stored and maintained in a garage. As is often the case, personal vehicles are stored in close proximity to larger automobiles or vehicles. As a result, operators frequently have to wheel personal vehicles into the garage by hand. This can be difficult given the weight of most personal vehicles. Furthermore, when these vehicles are being worked upon, the maintenance technicians often need to access all sides of the vehicle. This requires the user to frequently change positions or to manipulate the vehicle by hand. Requiring users to maneuver these heavy vehicles by hand can pose a danger to the vehicle and/or the user.

What is needed, therefore, is a caddy that permits personal vehicles to be transported, maneuvered and manipulated by a single user. The vehicle caddy of the present disclosure is designed to fulfill these and other shortcomings present in the art.

### SUMMARY OF THE INVENTION

This disclosure provides a vehicle caddy for storing, transporting, and maintaining a personal vehicle.

One advantage of the caddy is that two, three, and four wheeled vehicles can be transported, maneuvered, and manipulated by a single user.

A further advantage is realized by providing a caddy that allows personal vehicles to be easily positioned on and off of a platform associated with the caddy.

Yet another advantage is realized by providing a caddy that allows a vehicle to be easily rotated such that all sides of the vehicle can be easily accessed by a user.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a perspective view of the vehicle and caddy of the present disclosure.

FIG. 2 is a side elevational view of the vehicle and caddy of the present disclosure.

FIG. 3 is a top plan view of the vehicle and caddy of the present disclosure.

FIG. 4 is a front elevational view of the vehicle and caddy of the present disclosure.

FIG. 5 is a perspective view of the vehicle caddy of the present disclosure.

FIG. 6 is a side elevational view of a vehicle being positioned onto the vehicle caddy.

FIG. 7 is a side elevational view of a vehicle being positioned onto the vehicle caddy.

FIG. 8 is a side elevational view of a vehicle being positioned onto the vehicle caddy.

FIG. 9 is a perspective view of an alternative embodiment of the present invention.

Similar reference numerals refer to similar parts throughout the several views of the drawings.

Parts List

20 Caddy
22 Vehicle
24 Platform
26 Upper Surface
28 Lower Surface
32 Forward End
34 Rearward End
36 Side Edges
38 Knurled Surface
42 Wheels
44 Axle
46 Angled Wheel Support
48 Fork
52 Lock
60 Alternative Embodiment
62 Narrowed Platform
64 Side Platform

### DETAILED DESCRIPTION OF THE DRAWINGS

The present invention relates to a caddy system for personal vehicle. The term “personal vehicle” as used herein is intended as a broad classification for two and three wheeled motorcycles. It further includes three and four wheeled all-terrain (ATV) vehicles. In broad terms, the caddy includes a platform that is supported by a series of wheels. The caddy is designed to be tipped forwardly or rearwardly as needed to allow the vehicle to enter onto and exit off the platform. Once upon the caddy, a single user can easily move, maneuver, or manipulate the vehicle. This is ideal for storing and/or maintaining the vehicle. The various components of the present invention, and the manner in which they interrelate, are described in greater detail hereinafter.

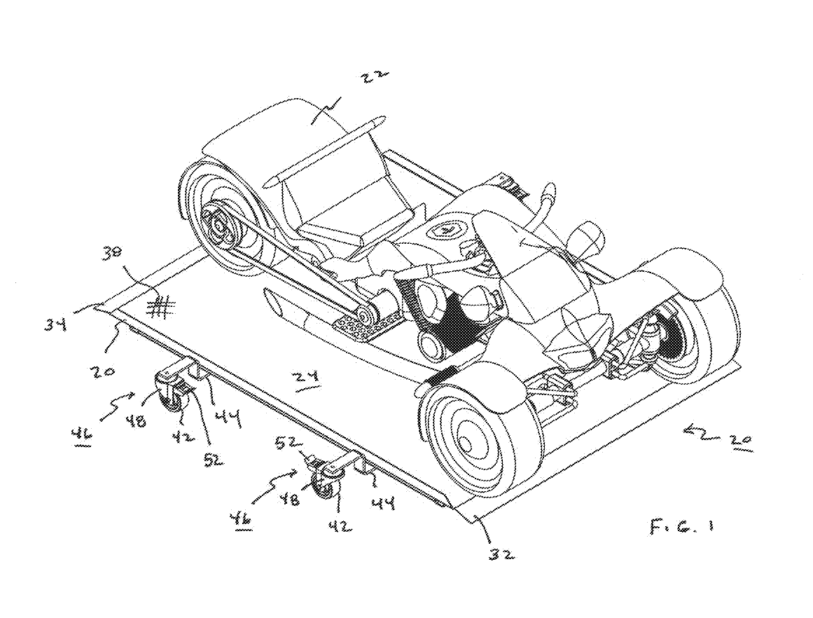

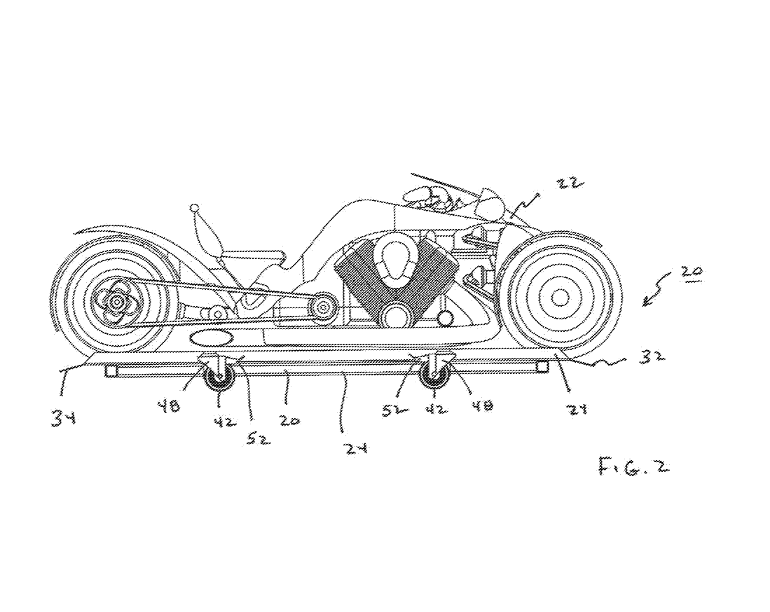

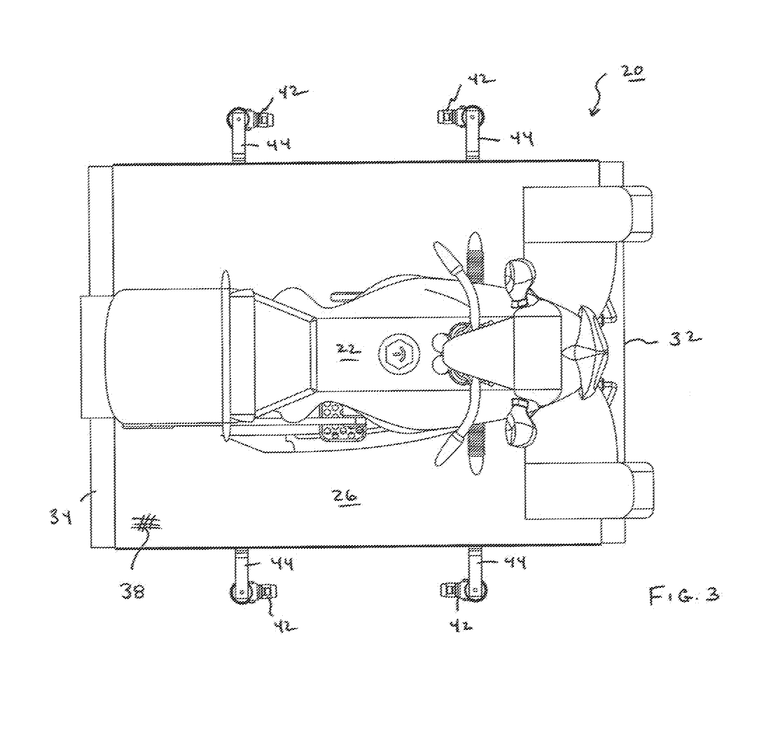

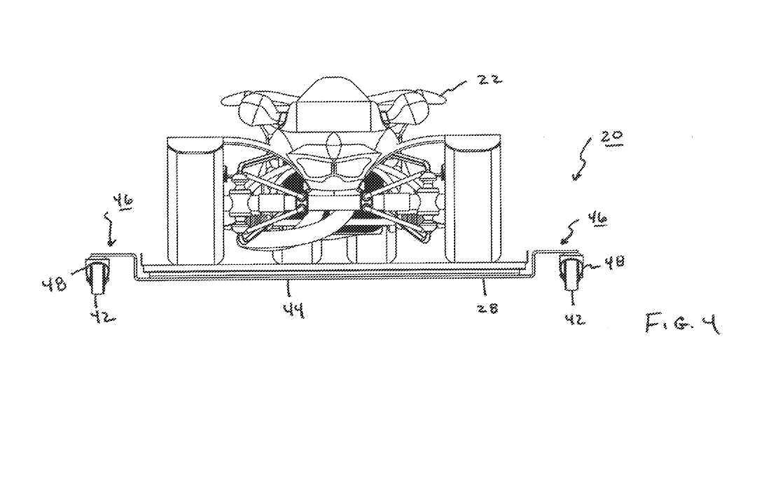

FIG. 1 illustrates a perspective view of the caddy 20 and vehicle 22 of the present invention. As illustrated, the major component of the caddy is a rectangular platform 24. Although the invention has been described in conjunction with a rectangular platform 24, any other platform configurations can be employed to suit the size and shape of the vehicle. In the depicted embodiment, platform 24 is defined by upper and lower surfaces (26 and 28), and forward and rearward ends (32 and 34). It is preferred that the opposing side edges 36 of the platform 24 be turned upwardly at a 90 degree angle to prevent objects from rolling, or falling, off the platform. Additionally, the forward and rearward most edges (32 and 34) of the platform 24 are angled downwardly. This allows a smooth transition as the vehicle 22 is rolled onto or off of the platform. The manner in which the vehicle 22 is positioned on the platform 24 will be described in greater detail hereinafter. Ideally, the upper surface 26 of the platform 24 can have a knurled or textured surface 38 to promote a sufficient grip between the vehicle tires and the caddy.

As illustrated, platform 24 is supported by a series of four wheels. Each wheel 42 is rotatably supported at the end of an axle 44. Each of the axles 44 preferably extends across the entire width of the lower surface 28 of platform 24. In an important aspect of the present invention, these axles 44 are positioned inward of the forward and rearward ends (32 and 34) of platform 24. In particular, each axle 44 is positioned approximately ⅓ of the overall length of the platform 24 from each respective edge. Namely, the distance between the axles is roughly equivalent to the distance between each axle and the adjacent forward or rearward edge. This allows platform 24 to be pivoted about either axle 44 as the vehicle 22 enters is rolled onto or off of the platform.

Each axle 44 terminates in a 90 degree angled wheel support 46. In other words, each axle 44 has a upwardly turned edge that allows the distal most end of each axle 44 to be positioned above the top surface 26 of the platform. This gives clearance for the wheels 42 of the platform, but nonetheless allows the platform 24 to be positioned at only a minimal distance off the ground. Each of the wheels 42 shows a similar construction and only one will be described in detail. Namely, each wheel includes a swiveled fork 48 which is secured onto the distal end of each axle. A wheel 42 is then rotatably secured to the fork 48 in a manner similar to a swivel castor. This allows the wheels 42 to have a free range of motion and allows them to freely support the platform 24. A wheel lock 52 can also be associated with the swivel to lock it at a particular angle or orientation.

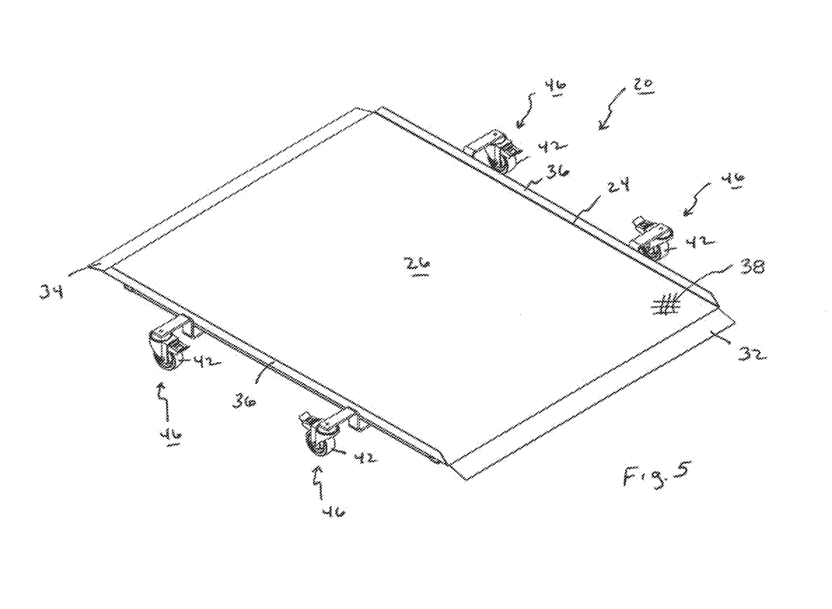

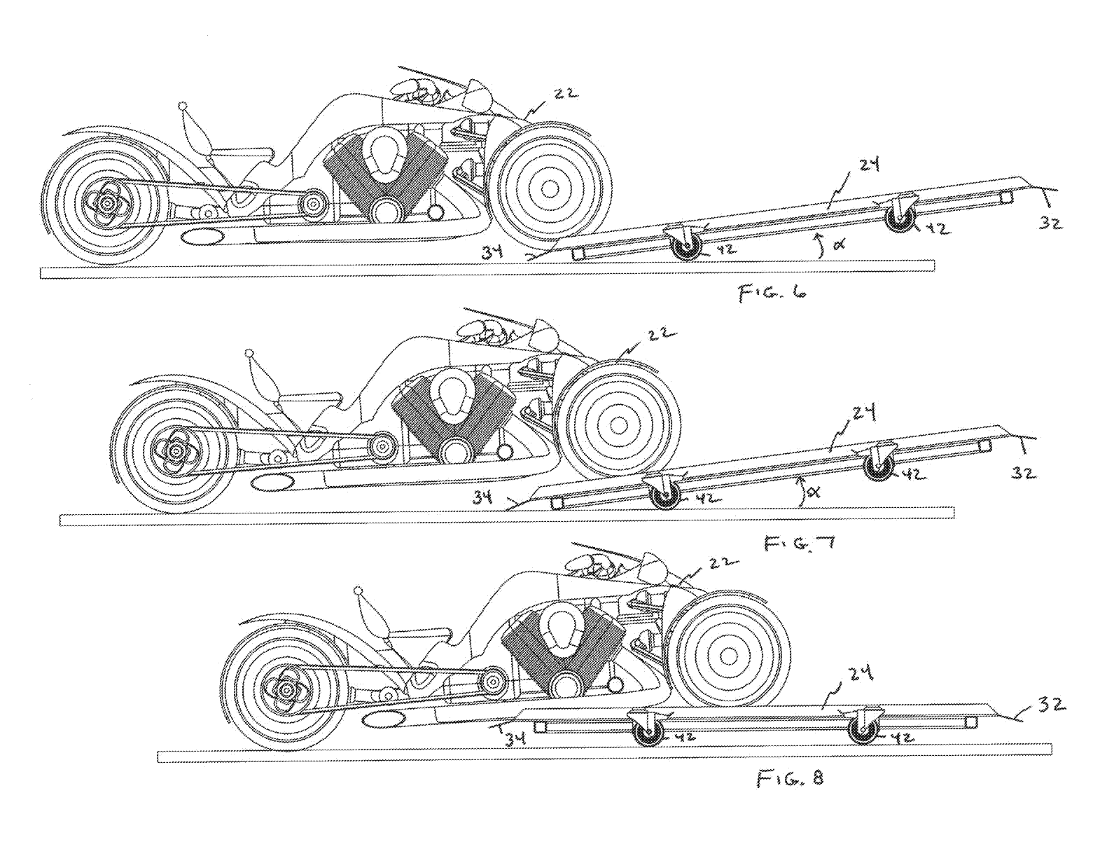

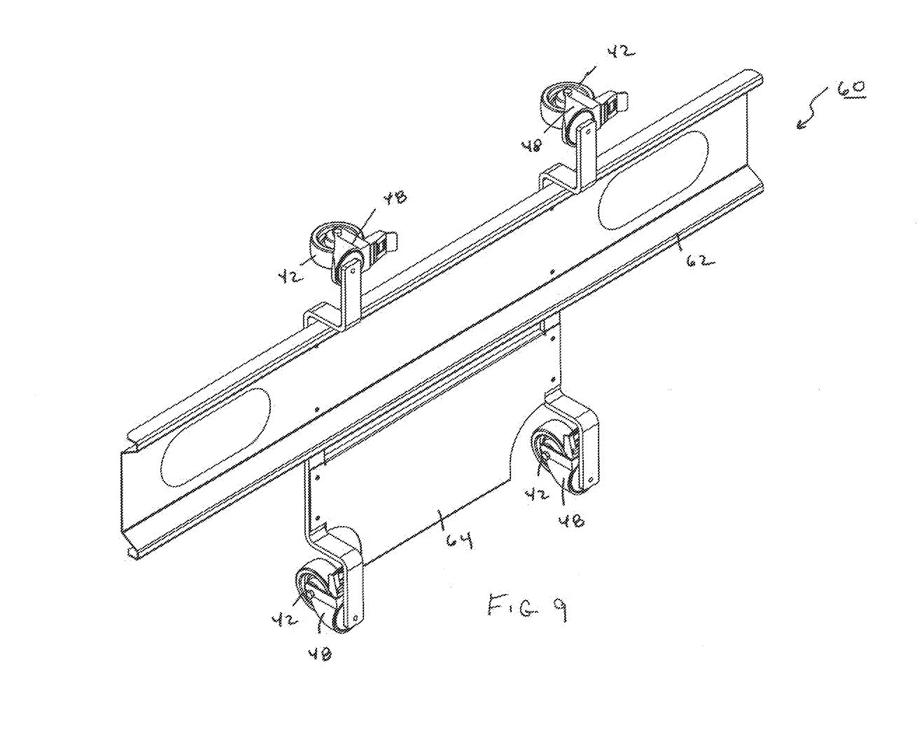

With reference now to FIGS. 6, 7, and 8, a sequence of mounting the vehicle onto the platform can be seen. In the first figure, the forward most wheels of the vehicle are positioned on the rearward end of the platform. This causes the platform to pivot about the rearward most axle to form an angle alpha a. Namely the front end of the platform and the forward axle is raised above the ground. At this point, the angled rearward edge of the platform engages the ground permitting the vehicle to be driven or pushed onto the platform. As the vehicle is extended onto the platform, the platform is pivoted downwardly such that all the wheels engage the ground. In this orientation the vehicle can be maneuvered for storage and/or maintenance by a single user. Once the user is done, the vehicle can be driven off or positioned off the forward edge of the platform in a similar fashion.

FIG. 9 is a depiction of an alternative embodiment 60. This embodiment is the same in all respects; however platform 62 is narrowed and specifically designed for a two wheeled vehicle. Platform 62 has cutouts to receive the vehicle wheels. A side platform 64 is included to accommodate a kickstand or other vehicle support.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A vehicle caddy system comprising:
a three wheeled vehicle including two forward wheels and one rearward wheel;
a rectangular platform supporting the three wheeled vehicle, the platform having an upper and lower surface, a width, the platform further including a forward and rearward ends, and an intermediate extent therebetween, the platform having opposing upstanding edges that extend between the forward and rearward end, angled edges extending along the width of the forward and rearward ends, the platform including a knurled surface to promote traction of the vehicle wheels;
first and second axles, each axle having opposing ends and extending the width of the platform along the intermediate extent, each opposing end terminating in a 90 degree angle wheel support, whereby each opposing end is at a position above the upper surface of the platform, each wheel support including a swivel and fork, with the fork rotatably supporting a wheel, a lock associated with each wheel support to lock the associated swivel and selectively prevent its rotation;
the first and second axles being positioned such that the platform can tip toward the forward or rearward end as the vehicle is being driving onto the platform.

2. A vehicle caddy system comprising:
a platform having an upper and lower surface, a width, the platform further including a forward and rearward ends, and an intermediate extent therebetween, angled edges extending along the width of the forward and rearward ends;
first and second axles, each axle having opposing ends and extending the width of the platform along the intermediate extent, each opposing end terminating in an angled wheel support, each wheel support including a swivel and fork, with the fork rotatably supporting a wheel.

3. The system as described in claim 2 wherein the first and second axles are positioned such that the platform can tip toward the forward or rearward end as a vehicle is being driving onto the platform.

4. The system as described in claim 2 wherein a lock is associated with each wheel support to lock the associated swivel and selectively prevent its rotation.

5. The system as described in claim 2 further comprising a three wheeled vehicle positioned upon the platform.

6. The system as described in claim 2 wherein the platform includes a knurled surface to promote traction of the vehicle wheels.
